(19) United States
(12) Patent Application Publication
(10) Pub. No.: US 2006/0084414 A1
(43) Pub. Date: Apr. 20, 2006

(54) Directory assistance with location information

(76) Inventors: William P. Alberth JR., Crystal Lake, IL (US); Patricia A. Robb, Prairie Grove, IL (US); William E. Welnick, Poway, CA (US)

Correspondence Address: MOTOROLA INC, 600 NORTH US HIGHWAY 45, ROOM AS437, LIBERTYVILLE, IL, 60048-5343, US

(21) Appl. No.: 10/966,625

(22) Filed: Oct. 15, 2004

(51) Int. Cl. H04Q 7/20

(52) U.S. Cl. 455/414.1

(57) ABSTRACT

A method for a mobile station to receive directory assistance by calling (501) a directory assistance system and providing (503) a directory assistance request. Depending on the preference of the user, the mobile station receives (550) a data message from the directory assistance system that includes a resulting telephone number and associated location information, just the resulting telephone number, or just the associated location information. The data is stored (552) to memory. Associated location information can be used (564) as a destination for a navigation system.

### FIELD OF THE DISCLOSURE

This disclosure relates generally to the field of communications, and in particular, to obtaining and using information from a directory assistance database.

### BACKGROUND OF THE DISCLOSURE

Directory assistance services provide information such as telephone numbers, addresses, electronic mail addresses, web site addresses, business names, personal names, and other similar types of contact information. Directory assistance information can be sorted by types of business (e.g., yellow pages or government listings) or alphabetically (e.g., white pages) or by other methods (e.g., reverse number look-up, nationwide vs. city/town-specific, etc.). In order to obtain a particular piece of information from a directory assistance service, an inquirer calls a directory assistance system and communicates a request including partial contact information (e.g., town and surname, town and business name, town and type of business, etc.). In a typical situation, the inquirer is seeking a particular telephone number, and the directory assistance system mechanically voices the telephone number resulting from the request. The inquirer may write down the resulting telephone number at this time. Additionally, at the inquirer's direction, the directory assistance system may forward the call to the resulting telephone number so that the inquirer need not separately dial the resulting telephone number.

A common reason for requesting directory assistance is to seek a telephone number and then be connected to that telephone number to obtain an address and directions to that address. For example, an inquirer looking for the location of a restaurant calls a directory assistance system from a mobile telephone while driving. The directory assistance system forwards the call to the resulting restaurant telephone number, and the inquirer obtains driving instructions from the restaurant. Thus, there is an opportunity to provide further directory assistance features to enhance existing directory assistance services.

The various aspects, features and advantages of the disclosure will become more fully apparent to those having ordinary skill in the art upon careful consideration of the following Drawings and accompanying Detailed Description.

### BRIEF DESCRIPTION OF THE DRAWINGS

FIG. 1 shows a mobile station call connection to a directory assistance system according to a first embodiment.

FIG. 2 shows a flowchart for providing directory assistance with or without location information according to the first embodiment.

FIG. 3 shows a directory assistance system sending a request result to a mobile station according to the first embodiment.

FIG. 4 shows the mobile station storing the request result in a memory according to the first embodiment.

FIG. 5 shows a flowchart for receiving directory assistance with or without location information according to the first embodiment.

### DETAILED DESCRIPTION OF THE PREFERRED EMBODIMENTS

A mobile station receives directory assistance with location information by calling a directory assistance system and providing a directory assistance request. Depending on the preference of the inquirer, the mobile station receives a data message from the directory assistance system that includes: a resulting telephone number and associated location information, just the resulting telephone number, or just the associated location information. This method conveniently stores results from a directory assistance system into a memory, such as a call stack or an electronic phonebook, and the results can be recalled for further use. For example, if the resulting telephone number is stored in a call stack, a user can quickly recall the telephone number and dial it using a “SEND” button. Associated location information can be recalled and used as a destination by a navigation service.

A directory assistance system receives a call from a mobile station including a directory assistance request and, depending on a preference for a form of a directory assistance result, sends a data message including a resulting telephone number and associated location information, a resulting telephone number only, or associated location information only. The directory assistance system can charge different rates based on the contents of the data message.

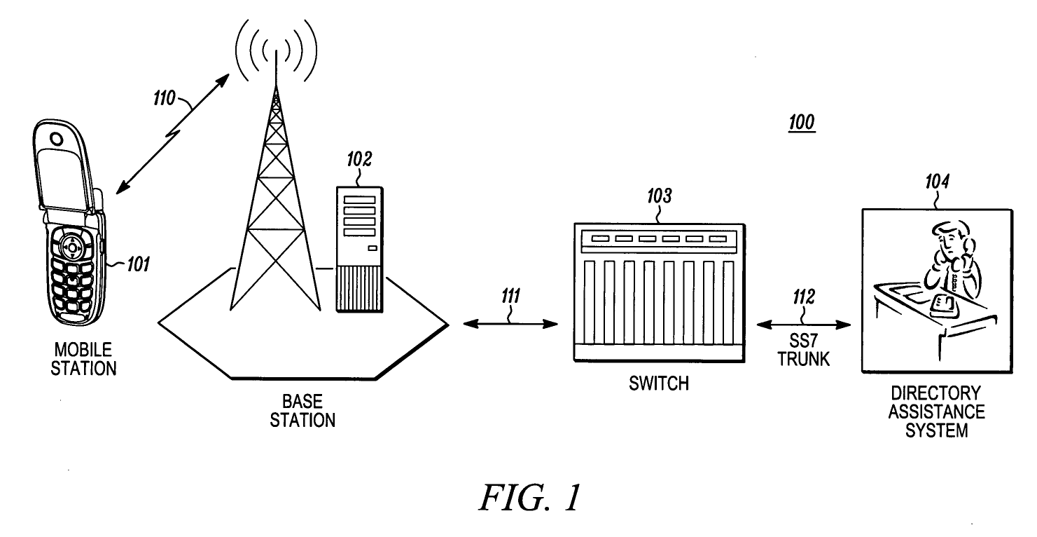

FIG. 1 shows a mobile station call connection 100 to a directory assistance system according to a first embodiment. A cellular mobile station 101 makes a call to a directory assistance system 104 requesting information such as a telephone number, a location, or both a telephone number and a location. The mobile station is shown as a CDMA cellular telephone; however, the mobile station can be implemented using other devices and other radio access technologies. For example, the mobile station could be a personal digital assistant with a GSM connection, a laptop computer with a wireless local area network (WLAN) connection, or a satellite phone with an IRIDIUM® connection.

A connection is made from the mobile station 101 to a base station 102 through a radio link 110 such as an IS-95 interface. The base station 102 is connected to a switching system 103 via a connection 111 such as an A+ link. The switching system 103, which may be a mobile switching center (MSC), is connected to a directory assistance system 104 via a connection 112 such as an SS7 trunk connection.

The mobile station 101 caller verbally makes a request for directory assistance and provides partial contact information to the directory assistance system. The directory assistance system 104 uses automated voice recognition, a live operator, or a combination of voice recognition and live operator to provide a result to the caller's request. Then, the directory assistance system 104 provides the results to the mobile station 101 through the switching system 103 and the base station 102.

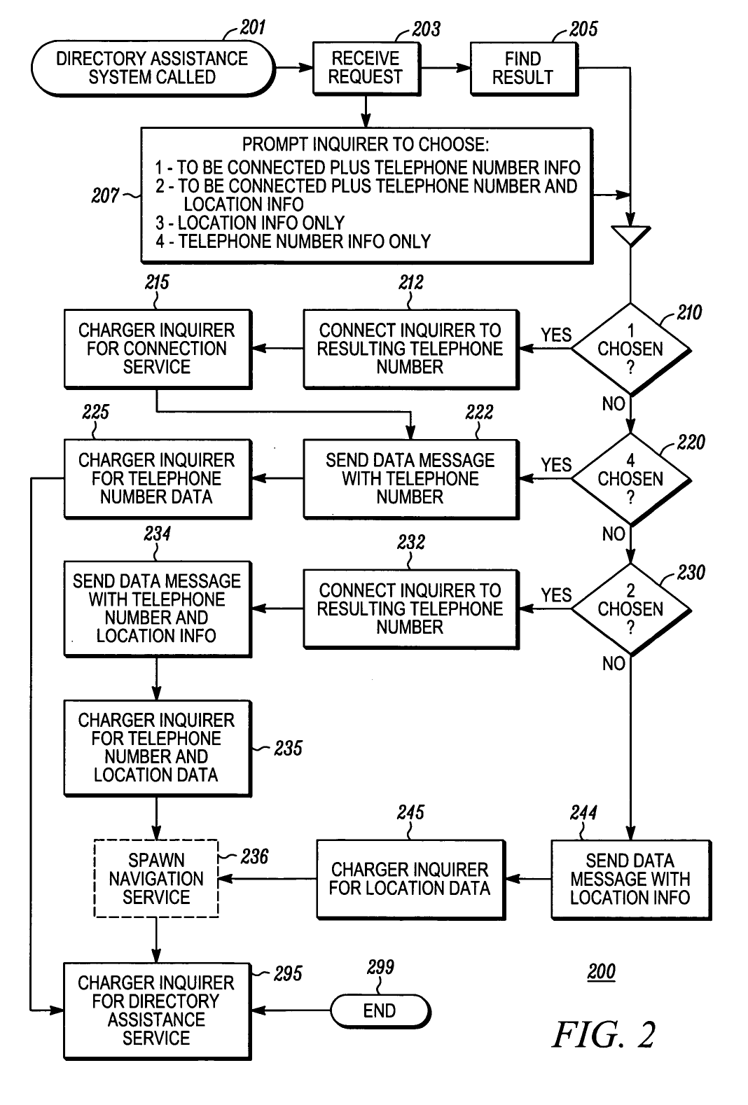

FIG. 2 shows a flowchart 200 for providing directory assistance with or without location information according to the first embodiment. Step 201 starts when a directory assistance system, such as the system 104 shown in FIG. 1, is called by a mobile station, such as the mobile station 101 shown in FIG. 1. In step 203, the directory assistance system receives a request including partial contact information for a person or business. Examples of requests include “Schaumburg, Motorola” or “Crystal Lake, Bill Alberth.”

Step 205 finds a result to the request. The request may be processed by an automated voice recognition system, a live operator, or a combination of the voice recognition and live operator. Meanwhile, step 207 prompts the inquirer for the preferred form of the result. In this first embodiment, the directory assistance system asks the inquirer to press or say “1” for the resulting number to be connected plus telephone number information, “2” for the resulting number to be connected plus telephone number and location information, “3” for location information only, and “4” for telephone number information only. Other combinations and permutations of directory assistance information can also be provided to the inquirer such as the full name of the resulting person or business, an electronic mail address, and a website address. Instead of prompting the inquirer to choose each time a request is received, a default choice may be provided or previously provided to the directory assistance system. The default choice could be determined by entities such as the inquirer, the directory assistance service provider, or the wireless service provider.

When a request result has been found, and when a caller has selected a preferred form of the result, the directory assistance system voices the result to the inquirer. Depending on the preferred form for the result selected by the inquirer, the voiced result could be a telephone number and/or location information with or without other directory information such as the full name of the requested person or business, an electronic mail address, or a website address. Next, step 210 determines if a first option “1” was selected. If so, step 212 connects the call to the resulting telephone number. Step 215 then charges the inquirer for the connection to the number. Step 222 sends a data message to the mobile station with telephone number information. For an IS-95 interface, such as the radio link 110 shown in FIG. 1, the data message received by the mobile station is a “Flash With Information” message containing the exact number, including international access code if needed, that would be dialed by the mobile station if it was placing a call directory to the result from the directory assistance system. Step 225 then charges the inquirer for the telephone number information. Step 295 charges the inquirer for the directory assistance service and step 299 ends the flow.

If a fourth option “4” was selected, as determined by step 220, the flow goes directly to step 222 to provide telephone number information to the mobile station using a data message as described earlier. Subsequently, step 225 charges the inquirer for the telephone number information, step 295 charges the inquirer for the directory assistance service, and step 299 ends the flow.

If neither option “1” nor option “4” was selected, step 230 determines if option “2” was selected by the inquirer. If option “2” was selected, step 232 connects the call to the resulting telephone number. Next, step 234 sends a data message to the mobile station with telephone number information and location information. Location information can be provided in a variety of formats depending on the directory assistance system and the mobile station. Further sub-options can be presented to the inquirer if a particular location information format is desired. For example, the directory assistance system can provide location information in street address form or latitude-longitude form. The inquirer may prefer a street address, but the mobile station may be able to provide navigation services better with latitude-longitude coordinates. Thus, the inquirer may request location information in both street address and latitude-longitude forms. On the other hand, the inquirer may only want street address form. Alternately, the inquirer may only want latitude-longitude form.

Optional step 236 spawns a navigation service that uses the location information as a destination. For example, the directory assistance system can forward the location information to a navigation service, such as VIAMOTO® navigation service, which uses the current location of the mobile station and the location information (provided in the format desired by the navigation service) from the directory assistance system to provide step-by-step driving instructions to the inquirer through the mobile station. If the mobile station supports simultaneous voice and data calls, the navigation service can be spawned immediately and occur concurrently with the directory assistance call. Otherwise, the navigation service can be directed to call the mobile station (or the mobile station can be directed to call the navigation service) upon termination of the voice call connected in step 232.

Not only can the directory assistance system spawn a navigation service, but the mobile station can alternately spawn a navigation service. After receiving the data message with telephone number information and location information, the inquirer can launch a navigation application on the mobile station using the location information a destination, or the navigation application can be automatically launched upon receipt of the location information. As with option “1” and option “4,” step 295 charges the inquirer for directory assistance service and the flow ends with step 299.

If step 230 determines that option “2” was not selected, then the flow assumes that option “3” was selected. Step 242 sends a data message containing location information only to the mobile station. As stated earlier, location information can be provided in a desired format as requested by the inquirer. Optional step 236 spawns a navigation service and passes the location information (in the format desired by the navigation service) to the navigation service as a destination. If the mobile station supports simultaneous voice and data calls, the navigation service can be spawned immediately and occur concurrently with the directory assistance call. Otherwise, the navigation service can be directed to call the mobile station upon termination of the directory assistance call, or the directory assistance call can be forwarded to the navigation service.

Not only can the directory assistance system spawn a navigation service, but the mobile station can alternately spawn a navigation service. After receiving the data message with location information, the inquirer can launch a navigation application on the mobile station using the location information a destination, or the navigation application can be automatically launched upon receipt of the location information. As with previous options, step 295 charges the inquirer for directory assistance service and the flow ends with step 299.

Depending on the cost structure of the directory assistance service, the various charging steps 215, 225, 235, 245, 295 can be combined and/or discounted (even down to “free of charge”) to provide various directory assistance service packages. Also, navigation service charges could be bundled with directory assistance service packages.

Thus, the directory service system can provide resulting telephone numbers, resulting location information, and other information to the mobile station in response to the inquirer's request. Not only can this information be stored at the mobile station for future use, but this information can be used by other services to provide step-by-step driving instructions.

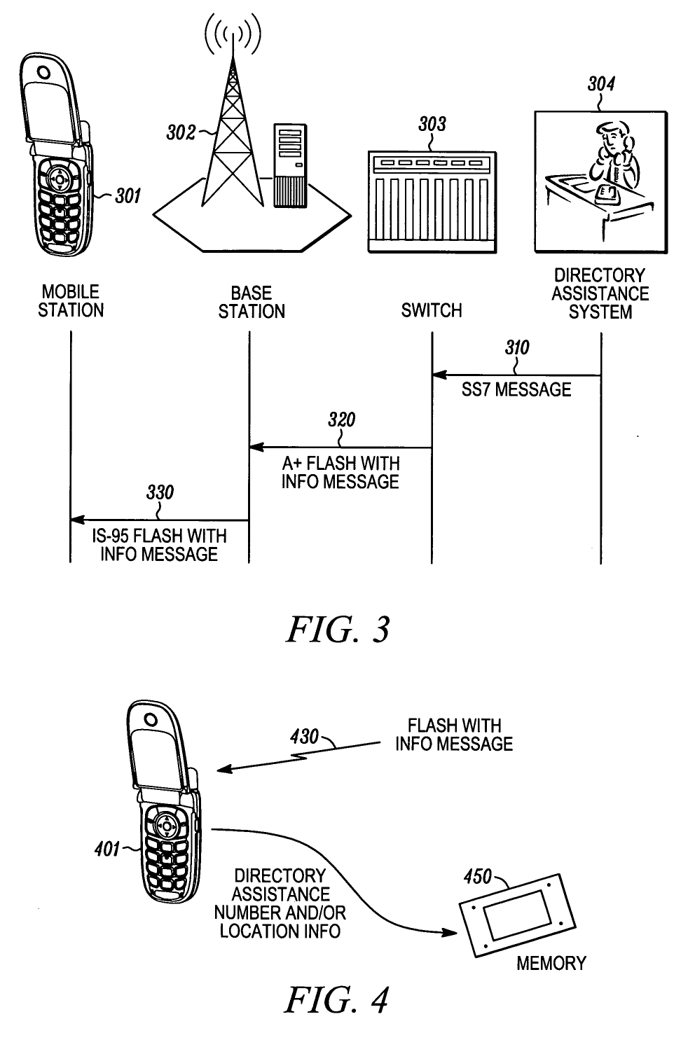

FIG. 3 shows a directory assistance system 304 sending a request result to a mobile station 301 according to the first embodiment. The mobile station 301 is shown as a CDMA cellular telephone such as the mobile station 101 in FIG. 1.

After the directory assistance system 304 determines a result to the request from an inquirer using the mobile station 301, the result (in the format requested by the inquirer as described with respect to FIG. 2) is entered into a data message. The result can be keyed in by a live operator, selected by a live operator to transfer to the data message, or simply entered by the directory assistance computer system without intervention by a live operator. Depending on the inquirer's request, the mobile station 301 may be connected to the resulting telephone number. Meanwhile, an SS7 message 310 is sent from the directory assistance system 304 to a switch 303. A data message 310 is sent regardless of whether the directory assistance system 304 forwards the call to a public switched telephone network for connection to the resulting telephone number. The SS7 message 310 contains the resulting telephone number, an associated location, or both. The SS7 message can also include other information from the directory assistance service such as an electronic mail address, a website address, or the full name of the resulting person or business.

The type of message 310 used for sending information to the mobile station 301 may be a Call Progress Message as described in ITU Q.763 Specifications for Signaling System No. 7, page 7. The Call Progress Message may include a Redirection Message as described in ITU Q.763 Specifications for Signaling System No. 7, page 8. The information parameter field can use a spare, such as all ones for bits C, B and A, to indicate that an operator redirected the call. The rest of the bits in this field would carry very little meaning for this type of message and therefore are irrelevant. The number itself would be formatted in the message as indicated in section 3.46 and 3.9 of the ITU Q.763 specification, pages 43 and 13-14. The number contained in this message should be in the world numbering format without any access code for international dialing.

Upon receiving the SS7 message 310, the switch 303 extracts the directory assistance number from the message 310 and creates an A+ message 320. MSC-BS “A” Interface Messages, as documented in System Interface Control document, ID: CIG-COM-GEN-SICD-007, released by Motorola on the 24 Nov. 1998, contains pertinent sections relating to message 302. The A+ message 320 may be used with a “Flash With Information” message and transmitted to the mobile station 301 via a message 330 from a base station 302, as described in “MSC-BS “A” Interface Messages,” page 34 of 116. This “Flash With Information” message 330 is defined to provide supplementary service information between a base station 302 and a mobile station 301. A sub-record within the Flash With Information record would be similar to the Calling Party Number record as described on page 110 of 116 of “MSC-BS “A” Interface Messages.” All parameters of the Calling Party Number-record are carried over into the new record for consistency and potential future use.

Table 1 shown below provides a format for the “Flash With Information” sub-record.

Directory Assistance Number

IS-95 Information Records Information Record Type

| User Data | | # of | | |
|---|---|---|---|---|
| Triplet | Description | Bytes | Bit Format | Range |
| Directory | This element | Variable | rrrr rrrr | R = 04H |
| Assistance | is used to | | nnnn nnnn | N = Variable^{a} |
| Number | convey The | | ttti iiip | t = 0H-02H^{b} |
| | directory | | pqqd dddd | i = 0H-01H^{c} |
| | assistance | | dddd dddd | p^{d} = 0H-02H |
| | number. | | ″ | q = 30H-39H (ASCII |
| | | | ″ | digits, 1 digit per byte, |
| | | | ″ | offset by 3 bits, up to |
| | | | ddd0 0000 | 32 digits possible) |

^{a}Indicates the number of bytes to follow, after this byte, within this Information Record Type,
^{b}Type of Number - values supported = 0H = Unknown, 01H = International number, 02H = National number.
^{c}Numbering Plan Id - values supported: 0H = Unknown, 01H = ISDN/Telephony numbering plan.
^{d}Presentation Indicator - values supported: 0 = Allowed, 1 = Restricted, 2 = Unavailable.
^{e}Screening Indicator - values supported: 0 = User provided, not screened, 1 = User provided, verified and passed, 2 = User provided, verified and failed, 3 = Network provided.

Latitude, longitude, and height coordinates can be included with the Directory Assistance Number. The information can be encoded per IS-801 Position Determination Service Standard for Dual-Mode Spread Spectrum Systems. For example: a ‘Type of Number’ value of 06H can be used to indicate location information. Following a ‘Type of Number=06H’ would be 25 bits for latitude, 25 bits for longitude, and 14 bits for height. The location information may be sent in the same data message as the phone number or in a separate data message. Other methods for encoding location information for transmission over a network can be substituted.

The value “r” is set to 04H as an indicator that this is a Directory Assistance Number sub-record; however, any unused value could be used for this indication. The resulting telephone number contained in this message would be a world number plus an international access code, if necessary. Therefore, this number would be the exact number that would be dialed by the mobile station 301 user to place a call directly to the telephone number provided by the directory assistance system.

Thus, the requested information, telephone number, location, or both, is transmitted from the directory assistance system 304 to the mobile station 301 through a switch 303 and a base station 302.

FIG. 4 shows the mobile station 401 storing the request result in a memory 450 according to the first embodiment. Upon receiving a Flash With Information message 430 from the directory assistance system, such as the message 330 shown in FIG. 3, the mobile station 401 stores the record containing the resulting telephone number and/or location information into a memory 450. The memory 450 may be an integral part of the mobile station 401 even though it is shown outside the mobile station 401 in this drawing. The memory can be implemented as a call stack (such as a “recently dialed number” stack), or an electronic phonebook, or a SIM card. The inquirer can recall the resulting information from the memory and use it or store it in another memory location. For example, after a resulting telephone number is recalled to a display location, pressing the SEND or TALK button initiates a call to that number. Because the resulting telephone number that was received in the data message has already been translated into a world number, the telephone number can be dialed or stored directly without modification by the mobile station. As another example, when resulting location information is recalled to a display location, pressing a soft key launches a navigation application with the mobile station's current location as a starting point and the location information as a destination. Additionally, pressing the store (STO) button on the mobile station 401 starts a sequence to store the resulting telephone number and/or location information in a permanent location such as an electronic phonebook.

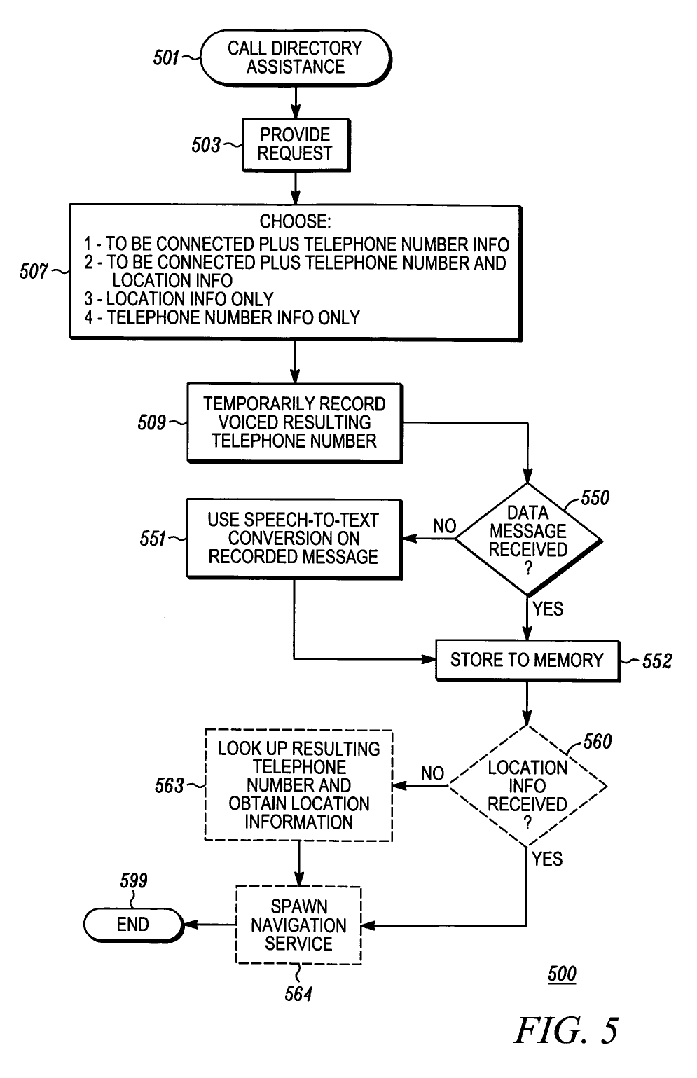

FIG. 5 shows a flowchart 500 for receiving directory assistance with or without location information according to the first embodiment. Step 501 starts when a mobile station, such as the mobile station 101 shown in FIG. 1, calls a directory assistance system, such as the system 104 shown in FIG. 1. In step 503, the inquirer provides a request including partial contact information for a person or business. Examples of requests include “Schaumburg, Motorola” or “Crystal Lake, Bill Alberth.” In step 507 the inquirer provides a preferred form of the result in response to a prompt from the directory assistance system. In this first embodiment, the inquirer presses or says “1” for the resulting number to be connected plus telephone number information, “2” for the resulting number to be connected plus telephone number and location information, “3” for location information only, and “4” for telephone number information only. The inquirer can request other combinations and permutations of available directory assistance information such as the full name of the resulting person or business, an electronic mail address, and a website address. Instead of prompting the inquirer to choose each time a request made, a default choice may be provided or previously provided to the directory assistance system. The default choice could be determined by entities such as the inquirer, the directory assistance service provider, or the wireless service provider.

In this first embodiment, when a request result has been found by the directory assistance system, the system voices the result to the inquirer. In this implementation, step 509 temporarily records the voiced result using a voice recorder in the mobile station. Depending on the preferred form for the result selected by the inquirer, the voiced result could be a telephone number and/or location information with or without other information such as the full name of the requested person or business, an electronic mail address, or a website address.

In step 550, the mobile station determines whether it has received a “Flash With Information” message from the base station containing the request result in the desired format. If no Flash With Information message is received, step 551 uses a speech-to-text converter to convert the recorded voiced result to text that can be stored in memory of the mobile station. The text from the conversion can be stored in an electronic phonebook or a SIM card. Note that if the mobile station does not expect a Flash With Information message, the speech-to-text conversion can be performed on the directory assistance voiced result rather than recording the voiced result and converting the recording to text.

If step 550 determines that a Flash With Information message has been received, step 552 stores the information in the Flash With Information message to a memory in the mobile station. A call stack (e.g., “recently dialed numbers”), an electronic phonebook, or a SIM card can serve as the memory that stores the information from the Flash With Information message. Once the resulting information is stored, it can either end at step 599 or trigger one or more optional steps.

Optional step 560 determines if location information was received in the Flash With Information message. If location information was not received, optional step 563 uses a data connection to look up the resulting telephone number on the World Wide Web, obtain associated location information, and store the location information into memory. This location information can be in any format useable by a navigation service compatible with the mobile station, such as street address or latitude-longitude format. The data connection can be automatically triggered by the receipt of a Flash With Information message that does not include location information, or the data connection can be manually triggered by the inquirer by recalling the Flash With Information message to a display memory and activating a soft key that directs the look-up of the telephone number on the World Wide Web.

Option step 564, which occurs after step 563 or directly from step 560 if step 560 determines that location information was received in a Flash With Information message, spawns a navigation service using the location information (either obtained from the World Wide Web or from the directory assistance system) as a destination and the current location of the mobile station as the starting point. This navigation session can be spawned automatically by receipt of a Flash With Information containing location information or it can be spawned manually. If the navigation session is spawned automatically, it can be concurrent with a voice call when simultaneous voice and data connections are supported by the mobile station. Otherwise, the data connection can be triggered to occur when the voice call is terminated. Either the mobile station can call the navigation service or the navigation service can call the mobile station when the voice call is terminated.

If the navigation session is manually spawned, the inquirer recalls the location information to a display memory and uses a soft key to spawn the navigation service using the current location of the mobile station as a starting point and the location information as a destination.

Directory assistance with location information uses a data message to transfer directory information from a directory assistance system to a mobile station. This directory information can be in a preferred form as requested by the inquirer. For example, the inquirer can request a resulting telephone number, location information by street address, location information by latitude-longitude coordinates, full name of the person or business, electronic mail address, website address, or other directory information. Once the data message is received by the mobile station, it is stored and can be used automatically by another application such as a navigation application or browser application, or the data message can be manually recalled and used by a navigation or browser application.

This application is particularly useful for situations where an inquirer would like to know a location, such as a street address for a restaurant, at a certain time but navigate to that location at a later time and from a different starting point.

While this disclosure includes what are considered presently to be the preferred embodiments and best modes of the invention described in a manner that establishes possession thereof by the inventors and that enables those of ordinary skill in the art to make and use the invention, it will be understood and appreciated that there are many equivalents to the preferred embodiments disclosed herein and that modifications and variations may be made without departing from the scope and spirit of the invention, which are to be limited not by the preferred embodiments but by the appended claims, including any amendments made during the pendency of this application and all equivalents of those claims as issued.

It is further understood that the use of relational terms such as first and second, top and bottom, and the like, if any, are used solely to distinguish one from another entity, item, or action without necessarily requiring or implying any actual such relationship or order between such entities, items or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore, further discussion of such software, if any, will be limited in the interest of brevity and minimization of any risk of obscuring the principles and concepts according to the present invention.

We claim:

1. A method for receiving directory assistance at a mobile station comprising the steps of:
calling a directory assistance system and providing a directory assistance request;
receiving a data message from the directory assistance system, the data message including a resulting telephone number and associated location information if a preference is for the resulting telephone number and associated location information;
storing the resulting telephone number in a memory of the mobile station; and
storing the associated location information in the memory of the mobile station.

2. A method according to claim 1 wherein the step of storing the resulting telephone number in a memory of the mobile station comprises:
storing the telephone number in a call stack.

3. A method according to claim 1 wherein the step of storing the resulting telephone number in a memory of the mobile station comprises:
storing the telephone number and the associated location information in an electronic phonebook.

4. A method according to claim 1 further comprising the steps of:
launching a navigation service using the associated location information as a destination.

5. A method according to claim 1 further comprising the step of:
receiving a data message from a directory assistance system, the data message including a resulting telephone number without associated location information if the preference is for the resulting telephone number without associated location information.

6. A method according to claim 1 further comprising the step of:
receiving a data message from a directory assistance system, the data message including resulting location information without an associated telephone number if the preference is for resulting location information without the associated telephone number.

7. A method according to claim 1 wherein the associated location information is in a street address form.

8. A method according to claim 1 wherein the associated location information is in a latitude-longitude form.

9. A method according to claim 1 further comprising the step of:
transmitting to the directory assistance system the preference, after the step of calling.

10. A method for receiving directory assistance at a mobile station comprising the steps of:
calling a directory assistance system and providing a directory assistance request;
receiving a voiced telephone number in response to the request;
performing a speech-to-text conversion on the voiced telephone number to create a text telephone number; and
storing the text telephone number into a memory.

11. A method according to claim 10 further comprising the step of:
recording the voiced telephone number to create a recording, wherein the speech-to-text conversion is performed on the recording.

12. A method according to claim 10 further comprising the step of:
finding associated location information for the text telephone number.

13. A method according to claim 12 further comprising the step of:
launching a navigation application using the associated location information as a destination.

14. A method for providing directory assistance from a directory assistance system to a mobile station comprising the steps of:
receiving a call from the mobile station including a directory assistance request;
receiving, from the mobile station, a preference for a form of a directory assistance result; and
sending a data message to the mobile station, the data message including a resulting telephone number and associated location information if the preference is for the resulting telephone number and associated location information.

15. A method according to claim 14 further comprising the step of:
forwarding the call to the resulting telephone number.

16. A method according to claim 15 further comprising the step of:
charging the mobile station for a service of forwarding the call to the resulting telephone number.

17. A method according to claim 14 further comprising the step of:
charging the mobile station for a service of responding to the directory assistance request.

18. A method according to claim 14 further comprising the step of:
spawning a navigation service with the associated location information as a destination.

19. A method according to claim 18 wherein the step of spawning comprises:
directing the mobile station to automatically spawn the navigation service when the associated location information is received by the mobile station.

20. A method according to claim 18 wherein the step of spawning comprises:
spawning the navigation service from the directory assistance system.

21. A method according to claim 18 wherein the step of spawning comprises:
spawning a navigation service when a user of the mobile station selects the associated location information.

22. A method according to claim 14 further comprising the step of:
sending a data message to the mobile station, the data message including a resulting location information without associated telephone number if the preference is for the resulting location information without associated telephone number.

23. A method according to claim 14 further comprising the step of:
sending a data message to the mobile station, the data message including resulting location information without an associated telephone number if the preference is for resulting location information without the associated telephone number.
